(19) United States
(12) Patent Application Publication
(10) Pub. No.: US 2015/0066342 A1
(43) Pub. Date: Mar. 5, 2015

(54) FLIGHT SCHEDULING, DISPATCH AND CHECK-IN

(71) Applicant: Flying Software Labs, LLC, Draper, UT (US)

(72) Inventor: Jack M. Garzella, Draper, UT (US)

(21) Appl. No.: 14/019,330

(22) Filed: Sep. 5, 2013

(51) Int. Cl. G09B 9/08; G08G 5/00

(52) U.S. Cl. CPC G09B 9/08; G08G 5/0026
USPC 701/120; 434/30

(57) ABSTRACT

Systems and methods are described for scheduling, dispatching and checking-in a flight event. A method may include receiving a request from a user to schedule a block of time for a first flight event, whereupon the block of time and an associated flight resource can be reserved for the block of time. The first flight event can be dispatched and a master flight record can be created for the first flight event. When the first flight event is checked-in, the master flight record can be updated with check-in data for the first flight event. When checking-in a first flight event, a second flight event can be checked-in and a master flight record can be created for the second flight event. Check-in data can be received for the second flight event and the master flight record associated with the second flight event can be updated with the check-in data.

### BACKGROUND

Those wishing to become aircraft pilots in most cases attend a flight training school where a course of study is used to teach a student to pilot an aircraft. Through flight training, a student may be taught primary and intermediate airmanship skills that provide the student with an acquaintance of the principles of flight. As a result, a student may leave flight school having an ability to operate an aircraft with competence and precision on the ground and in the air, as well as the ability to exercise good judgment in the operation, safety and efficiency of an aircraft.

In addition to managing the ordinary operations of a flight training business, some flight training schools may be subject to government scrutiny. For instance, aircrafts, flight instructors and pilot training activities may be regulated by governments. Due to flight training related regulations, flight training schools may be burdened with additional procedures, rules and paperwork that add complexity to managing a flight training school. For example, pilot certification may require: minimum flight instruction time, individual solo flight time, minimum age requirement, medical certification and successful completion of a number of written, oral and flight tests. In addition, flight instructors may be regulated and may need to be certified in order to instruct a student. In a case where a requirement may have been missed or neglected, a flight training school may face serious consequences.

### BRIEF DESCRIPTION OF THE DRAWINGS

FIG. 1 is a diagram illustrating an example system for scheduling, dispatching and checking-in one or more flights.

FIG. 2 is a block diagram illustrating an example system for scheduling and dispatching a flight.

FIG. 3 is a diagram that illustrates an example graphical user interface that may be used to schedule a flight event.

FIG. 4 is a flow diagram illustrating an example method for a preflight check-out for a flight event that has been scheduled using a flight management system.

FIG. 5 is a flow diagram that illustrates an example method for checking-out a scheduled flight event using a flight management system.

FIG. 6 is a flow diagram illustrating an example method for checking-in a flight event using a flight management system.

FIG. 7 is a flow diagram illustrating an example method for performing a post-flight review using a flight management system.

FIG. 8 is a flow diagram illustrating an example method for scheduling, checking-out and checking-in a flight event.

FIG. 9 is a block diagram illustrating an example of a computing device used for scheduling and dispatching a flight event.

### DETAILED DESCRIPTION

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical terms used herein have the same meaning as commonly understood by one of ordinary skill in the art to which this disclosure belongs.

A technology is described for scheduling, dispatching and checking-in one or more flight events using a flight management system. A flight management system may support entities that operate flight businesses and/or clubs. For instance, a flight entity may include, but is not limited to, flight schools that teach students to operate various aircraft, flight businesses that rent and/or charter aircraft to the public and flight clubs comprised of member pilots. A flight management system may be used to track a student pilot's progress, validate that flight training rules are being followed, track aircraft used by a flight entity, schedule flight resources and courses, ensure compliance to governmental regulations and proprietary rules, or integrate billing features as well as other functions related to a flight entity. For example, a flight management system may help flight schools to adhere to FAA (Federal Aviation Administration) rules and regulations by monitoring student and instructor compliance to the rules and regulations.

Within a flight management system, a flight event can refer to events that might occur within a flight entity. For instance, a flight event may be, but is not limited to, a flight lesson, a ground lesson, an aircraft rental, a flight simulator lesson and/or rental, etc. When a flight event is scheduled within a flight management system, the process of dispatching (checking-out) and checking in the flight event can entail multiple steps. For example, dispatching a flight lesson can include specifying one or more pilots, an instructor, an aircraft, aircraft details (service hours, maintenance information, etc.), flight rules, pre-flight information as well as additional information. As can be appreciated, a good deal of information may be requested at the time a flight event is dispatched. Likewise, at the time of checking-in a flight event, a number of items may be requested. For instance, billing time, aircraft service time, total flying time, daylight flying time, night flying time, cross-country flying time, take offs, landings, etc.

Currently, flight entities that use existing systems may be limited to scheduling, dispatching and checking-in a single flight event. In a case where a flight event may result in two or more separate flight events (e.g., two flight lessons), a user may have to check-in the original flight event (e.g., check-in the original flight event for the first flight lesson), and then create an additional flight event (e.g., the second flight lesson), and reenter the check-out information from the original flight event prior to checking-in the additional flight event (e.g., second flight lesson).

As an example, an originating flight event, namely a flight lesson involving a student pilot may cover details that relate to two different lessons, which can result in two flight lessons rather than a single flight lesson. When checking in the flight lesson, the first flight lesson may be checked-in, and then a user may have to create and schedule a new flight lesson for the second lesson as though the second flight lesson has not yet occurred.

When a flight event results in multiple flight events, the present technology allows a user to reuse information from the check-out (dispatch) of the originating flight event and check-in the additional flight events when the originating flight event is checked-in. Using the example above, a flight lesson that results in two flight lessons can be checked-in using the present technology without having to first check-in one flight lesson and then start the process over again to create, check-out and check-in the second flight lesson. Rather, a user may check-in the first flight lesson and then the user may be presented with an option to check-in the second flight lesson. When checking-in a second flight event, the flight management system can copy information from the first flight event and then use the information to create the second flight event, which the user may then check-in at that time.

In addition to a benefit of reusing check-in information for multiple check-ins, providing an option to check-in additional flight events can result in better record management. For example, FAA regulations and rules may stipulate that accurate records be maintained for flight lessons when training a pilot. For instance, flight lesson records may show an amount of time a student piloted an aircraft during a flight lesson. When a flight lesson results in multiple flight lessons, each flight lesson record needs to reflect an accurate amount of time that the student piloted the aircraft. Using the present technology, the originating flight lesson can be checked-in, and then any additional flight lesson can be checked-in. When checking-in the originating flight lesson, a flight time for the lesson can be entered, then when the next flight lesson is checked-in, the system can copy the information from the originating flight lesson and use the ending flight time of the originating flight lesson as a start time of the next flight lesson being checked-in. Thus, the present technology can help to ensure accurate time keeping of the multiple flight lessons, and therefore, more accurate flight lesson records.

The ability of a user to schedule a flight event using a flight management system may be determined by one or more user roles and one or more user profiles that may be associated with a user. A user role may define a user's place within a flight management system's hierarchy and may define certain system rights granted to the user. For example, a user role may be an administrator (admin), instructor, pilot, maintenance, staff, etc. A user profile may be a collection of attributes associated with a user that can be used to determine, based on the attributes, whether the user can perform certain actions within the flight management system. For example, attributes from a user's pilot profile may be used to determine whether the user may be qualified to operate a particular aircraft that may be available to rent.

In one example configuration, the present technology may allow a user of a flight management system to schedule a flight event. Once a flight event has been scheduled, the flight event may be dispatched or checked-out. Dispatching a flight event can involve providing the flight management system with check-out information, including information about who may be checking-out the flight event, information about a flight resource that may be used, information about an instructor that may take part in the flight event, lesson details, start time and any other information that may be related to dispatching the flight event.

Upon dispatching a flight event, a master flight record may be created for the flight event. A master flight record may contain information pertaining to the flight event and may be used for any purpose within a flight management system that pertains to an associated flight event (e.g., invoicing, records management, regulation compliance, etc.). For instance, a master flight record may include, but is not limited to, a date for the flight event, a flight event start time, pilot information, flight resource information, flight plan, starting hobbs meter time(s), flight lesson (ground and/or air), flight notes, weather forecast, etc. Depending upon a type of flight event, a master flight record may contain information that may be specific to the type of flight event. For example, a master flight record may contain instructor information when a flight event is a flight lesson.

When a flight event is completed and checked-in, additional information may be added to the master flight record. For example, a check-in time, ending hobbs meter time, total flying time, locations flown, actual flight plan (vs. planned flight plan), number of landings, oil and fuel used, day, night, actual instrument and other log book flight times, flight notes, other expenses for the flight, lesson details (if a lesson is conducted), etc. After checking-in a flight event, the flight management system may provide a user with an option to add a second flight event that may be associated with the flight event which was dispatched and that the user then checked-in. As an example, a flight event may have been dispatched for a flight lesson for a student pilot. A first student pilot and a second student pilot may have been onboard an aircraft that was used for the flight lesson. The first student pilot may have piloted the aircraft from a first airport to a destination. The second student pilot may have then piloted the aircraft from a second airport to a destination. Thus, during the flight event, two flight lessons occurred. When the flight event is checked-in, the user checking-in the flight event may check-in a flight lesson for the first student pilot, and then check-in a second flight lesson for the second student pilot.

When a second flight event is checked-in, a new master flight record may be created and selected information from the original flight event that was added at dispatch and the first check-in may be added to the new master flight record. In addition to the second flight event, additional flight events may be created and checked-in at the time that an originating associated flight event is checked-in.

Typically, in order to create a second flight event, information associated with dispatching a flight resource such as an aircraft is manually entered, followed by the manual entering of information associated with checking in the flight event. The amount of information that is typically entered at dispatch and check-in can be significant, as previously discussed. The ability to create new flight events automatically using information from the master flight record for the dispatch and the first check-in can save significant time and effort while reducing data errors that could cause compliance issues during an audit.

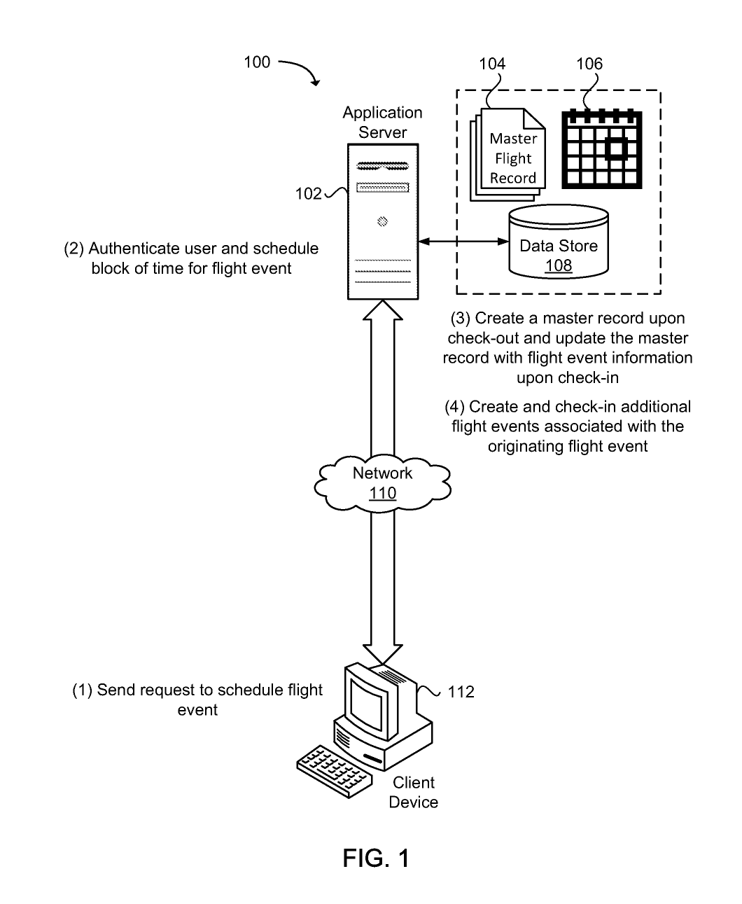

FIG. 1 is a diagram illustrating a system 100 for scheduling a flight event, dispatching the flight event and checking-in the flight event as well as creating any additional flight events that may be associated with the originating flight event. The system 100 may include a client device 112 that may be in communication via a network 110 with a flight management system that may be executed on an application server 102. The application server 102 may include a data store 108, upon which a flight event schedule 106 and a number of master flight records 104 may be stored. A user may request to schedule a flight event using the client device 112. The request may be transmitted to the application server 102 over the network 110 where, upon receiving the request, the application server 102 may authenticate the user. A user may be authenticated using a role and a profile that may be associated with the user. For example, a flight management system executing on the application server 102 may be accessed by a number of users, each of which may be assigned one or more roles and one or more profiles.

A role may determine which system rights a user may have within the flight management system (e.g., view, create, etc.) and may determine which information the user may view (e.g., pilot information, aircraft maintenance information, instructor information, etc.). A flight management system may contain various roles, including an administrator role, pilot role, instructor role, maintenance role, staff role, as well as other types of roles that can be created within the flight management system. A role may enable a user to perform certain actions within the flight management system. As an example, a user wishing to schedule a flight event may need to be assigned a role that provides the user with scheduling rights within the flight management system. For example, a user that may be assigned a pilot role may have the ability to schedule an airplane rental and a user with an instructor role may have the ability to schedule a flight training course.

A profile may be related to a role and the profile may contain information that may be related to a role. For example, a user that has a pilot role may also have a pilot profile. The pilot profile may contain information that may be related to the pilot role. For instance, information that may be included in the pilot profile may be a pilot's medical certification, citizenship status, pilot certificate and/or flight hour information. The information contained in a profile may be used to determine whether a user may be certified to perform a certain action within a flight management system. For example, if a user attempts to schedule a rental of an airplane, then information contained in the user's profile may be examined to determine whether the user is certified to fly the airplane. If the user is not certified to operate the airplane, then the user may be prevented from scheduling a rental of the airplane.

Once a user has been authenticated to schedule a flight event based on the user's role and profile, a flight resource that may be associated with the flight event may be identified and a determination may be made whether the flight resource may be available during the block of time that the user may be requesting to schedule the flight event. A flight resource may be any resource that a flight entity may have rights to. For example, a flight resource may include, but is not limited to, an aircraft, equipment, building, room, personnel, training materials, etc. In a case where the flight resource may be available during the requested block of time, the flight event may be scheduled for the user by adding the flight event to the flight event schedule 106, thereby reserving the flight resource for the flight event.

When a user accesses the flight management system to check-out (dispatch) a flight event, a master flight record 104 may be created for the flight event. Information about the flight event may be recorded on the master flight record 104. For example, a check-out date, a start time, a flight resource (e.g., aircraft, simulator, classroom, etc.) as well as any other information that may be relevant to the flight event. Once created, the master flight record 104 may be saved to the data store 108 where the master flight record 104 may be accessible to the flight management system. Later, when a user accesses the flight management system to check-in the flight event, the master flight record 104 may be retrieved from the data store 108 and the master flight record 104 may be updated to include information about the flight event that may have occurred during the flight event. As an example, check-in flight event information may include an ending time, a total billing time, flight lesson information, and any other information that may be relevant to the flight event.

When checking-in a flight event, a user may have an option to create one or more flight events that may be associated with the originating flight event (i.e., the original event that was scheduled and checked-out) and then the user may check-in the one or more flight events. A master flight record 104 may be created for each additional flight event and information pertaining to the originating flight event may be written to the newly created master flight records 104. As an example, an originating flight event may include scheduling a flight simulator (or aircraft) for a flight simulation lesson (or flight). During the block of time scheduled for the flight simulation lesson, a first student may have conducted a flight simulation, and then later, a second student may have conducted another flight simulation. When an instructor that taught the flight simulation lesson accesses the flight management system to check in the flight simulation lesson, the instructor may check-in the original flight simulation lesson for the first student. Rather than perform the steps of scheduling another flight simulation lesson for the second student and then check-out and check-in the flight simulation lesson, the instructor may, at the time the original flight simulation lesson is checked-in, create an additional flight simulation lesson for the second student and then check-in the additional flight simulation lesson. Thus, by creating and checking-in additional flight events that may be related to an originating flight event, a user may not need to reenter duplicate information for each additional flight event created.

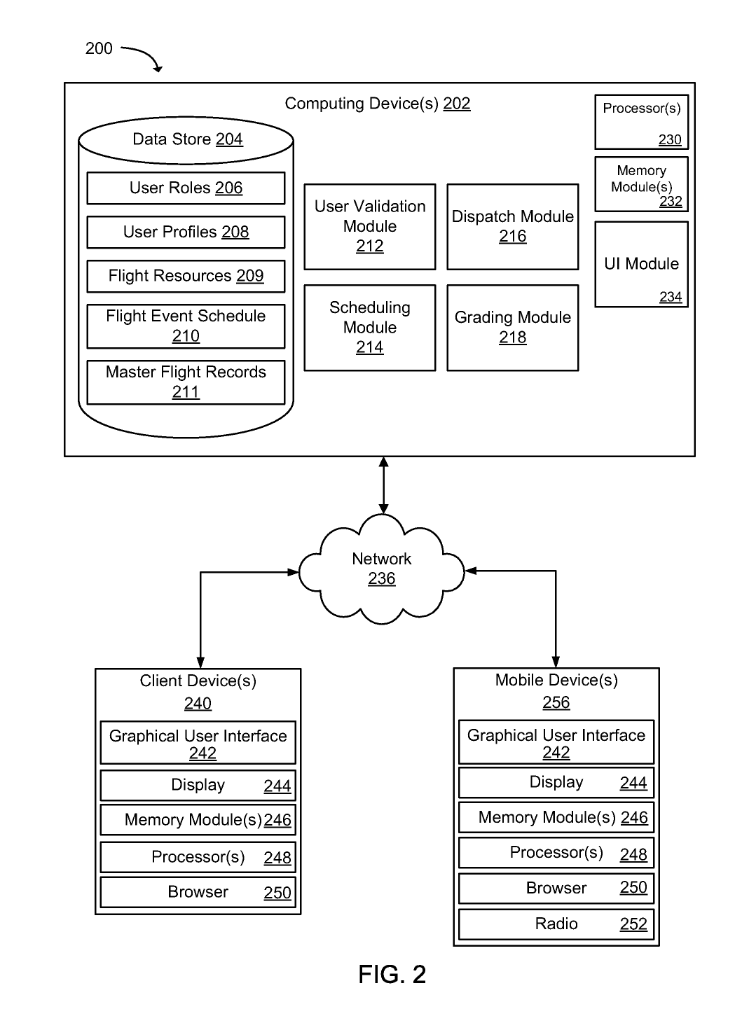

FIG. 2 illustrates an example of various components of a flight management system 200 used for scheduling a flight event, dispatching the flight event and checking-in the flight event along with additional flight events that may be associated with an originating flight event. The flight management system 200 may contain one or more computing devices 202 that may be in communication with a number of client devices 240 and/or mobile devices 256 by way of a network 236.

In one example configuration, the computing device 202 may include a data store 204 that contains various data, including user roles 206, user profiles 208, flight resources 209, a flight event schedule 210 and master flight records 211. The computing device 202 may include modules containing instructions that when executed by a processor 230 perform certain actions. These modules may include a user validation module 212, a scheduling module 214, a dispatch module 216, a grading module 218, a user interface module 234 as well as other services, processes, systems, rules engines, or functionality not discussed in detail herein. The user validation module 212 may be configured to identify one or more user roles 206 and one or more user profiles 208 that may be stored in the data store 204 for a user. A user role 206 may be used to determine a level of security within a flight management system 200 that may be granted to a user. In some cases, a user may be assigned multiple user roles 206 that allow the user to access different aspects of a flight management system 200. For example, in a flight management system 200 that contains user roles 206 for pilots, instructors, staff and maintenance, a user may be assigned one or more of these user roles 206. For instance, a user may be both a pilot and an instructor. Moreover, the user may also be employed by a flight entity as a staff member who manages a reception desk and also works as an aircraft maintenance employee for the flight entity.

The user validation module 212 may also identify at least one user profile 208 having user profile data for a user. A user profile 208 may be a collection of attributes that identify and describe a user. As an example, a user profile 208 may contain personal information about a user and information that relates to one or more user roles 206 associated with the user in the flight management system 200. For example, a user having a maintenance user role may have an associated maintenance user profile that may contain information about various aircraft maintenance certifications that the user may have completed. By means of a user role 206 and a user profile 208, the user validation module 212 can validate a user who may request to create a flight event. The user role 206 may determine whether the user is authorized to create the flight event and information from the user profile 208 may be used to determine whether the user possesses the proper credentials to create the flight event.

After verifying that a user has a valid user role 206, the user validation module 212 can provide a rules engine with information from a user profile 208. The rules engine can use the information from the user profile 208 to determine whether the user profile 208 contains appropriate information that would allow the user to create and schedule a flight event. As an example, a user wishing to schedule a helicopter using a flight management system 200 may make the request to schedule the helicopter by providing the user's credentials (e.g., login information). The user validation module 212 can then determine whether the user has a pilot user role and then determine whether the user has a pilot profile containing the appropriate information that allows the user to operate the type of helicopter requested by the user.

Once a user role 206 and user profile 208 have been validated by the user validation module 212, a request to schedule a flight event may be received by the scheduling module 214. The scheduling module 214 can then schedule a block of time for the flight event in the flight event schedule 210 and can reserve a flight resource 209 for the flight event. The flight event schedule 210 may be an electronic calendar stored in the data store 204 that can be made available to users of the flight management system 200. The flight event schedule 210 may be divided into segments or blocks of time. When a flight event and an associated flight resource are scheduled for a block of time, a record may be created and the record may be displayed in the flight event schedule 210 for the block of time. The record shown in the block of time can indicate that the flight event has been scheduled and that any related flight resources may be unavailable during the block of time.

A dispatch module 216 may be configured to check-out (dispatch) and check-in a scheduled flight event. In one example, a flight event may be dispatched or checked-out using the flight management system 200. A user may locate the scheduled flight event within a flight event schedule 210 and select an option to check-out the flight event. The flight management system 200 may request information associated with the flight event (e.g., pilot information, instructor information, aircraft information, etc.) and then provide the user with a check-out checklist. The check-out checklist may be a list where each item may include a passed or failed designation. For example, upon check-out, items associated with an aircraft that will be used during the flight event may be compared to a set of criteria. The comparison of the item with the criteria may result in a passed or failed designation. As a specific example, an item that may be compared to a criterion may be an aircraft maintenance due date. In a case where an aircraft may be past due for a maintenance inspection, the item may receive a failed designation in the check-out checklist.

Upon check-out, a master flight record 211 may be created for the flight event. The master flight record 211 may contain, but is not limited to, a date, a start time, an end time, a pilot, an instructor, a flight resource and any other information that may be related to the flight event. Upon checking-in a flight event, the master flight record 211 may be updated with information about the completed flight event. In addition to checking-in an originating flight event, the dispatch module 216 may allow a user to check-in additional flight events that may be related to the originating flight event. For each additional flight event that may be checked-in, a master flight record 211 may be created for the additional flight event and information from the originating flight event may be copied to a master flight record 211 for an additional flight event.

The flight management system 200 may include a grading module 218 that may be configured to receive a post-flight review from a pilot or an instructor. In one example, the post-flight review may include information that can be used to grade a flight event and update a master flight record 211 with a grade for the flight event. For example, a flight event may be a flight lesson for a student pilot. The flight lesson may include an instructor who may evaluate the student pilot during the flight lesson. At the conclusion of the flight lesson, the instructor may determine a grade for the flight lesson. The instructor may enter the grade into the flight management system 200 and the grade and any other information related to the flight lesson may be received by the grading module 218. The grading module 218 may then update the master flight record 211 with the grading information.

The client device 240 and the mobile device 256 included in the flight management system 200 may include any device that may be capable of sending and receiving data over a network 236. The network 236 may be a wired or a wireless network such as the Internet, a local area network (LAN), wide area network (WAN), wireless local area network (WLAN), or wireless wide area network (WWAN). The WLAN may be implemented using a wireless standard such as Bluetooth or the Institute of Electronics and Electrical Engineers (IEEE) 802.11-2012, 802.11ac, 802.11ad standards, or other WLAN standards. The WWAN may be implemented using a wireless standard such as the IEEE 802.16-2009 or the third generation partnership project (3GPP) long term evolution (LTE) releases 8, 9, 10 or 11. Components utilized for such a system may depend at least in part upon the type of network and/or environment selected. Communication over the network may be enabled by wired or wireless connections and combinations thereof

A client device 240 may comprise, for example, a processor-based system such as a computing device. Such a computing device may contain one or more processors 248, one or more memory modules 246 and a graphical user interface 242. A client device 240 may be a device such as, but not limited to, a desktop computer, mainframe computer system, workstation as well as other devices with like capability. A mobile device 256 may be a device such as laptop or notebook computer, tablet computer, handheld computer, smartphone or other devices with like capability. The client device 240 and the mobile device 256 may have one or more applications 252 installed that may provide access to a flight management system 200. Also, a client device 240 and a mobile device 256 may include a browser 250 that may enable the communication with the computing device 202 by way of a server side executed application that may be displayed within the browser 250. The mobile device 256 may contain a radio 252 that enables the mobile device 256 to connect to a network 236 by way of a wireless local area network connection such as WI-FI or Bluetooth. The client device 240 and the mobile device 256 may include a display 244, such as a liquid crystal display (LCD) screen, gas plasma-based flat panel display, LCD projector, cathode ray tube (CRT), or other types of display devices, etc.

The various processes and/or other functionality contained on the computing device 210 may be executed on one or more processors 230 that are in communication with one or more memory modules 232 according to various examples. The computing device 210 may comprise, for example, of a server or any other system providing computing capability. Alternatively, a number of computing devices 210 may be employed that are arranged, for example, in one or more server banks or computer banks or other arrangements. For purposes of convenience, the computing device 210 is referred to in the singular. However, it is understood that a plurality of computing devices 210 may be employed in the various arrangements as described above.

Various data may be stored in the data store 204 that is accessible to the computing device 202. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 204 may include storage systems such as a SAN (Storage Area Network), cloud storage network, volatile or non-volatile RAM, optical media, or hard-drive type media. The data store 204 may be representative of a plurality of data stores 204 as can be appreciated.

FIG. 2 illustrates that certain processing modules may be discussed in connection with the present technology and these processing modules may be implemented as computing services. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that are hosted in a server, cloud, grid or cluster computing system. An application program interface (API) may be provided for each module to enable a second module to send requests to and receive output from the first module. Such APIs may also allow third parties to interface with the module and make requests and receive output from the modules. While FIG. 2 illustrates an example of a flight management system 200 that may implement the techniques above, many other similar or different environments are possible. The example environments discussed and illustrated above are merely representative and not limiting.

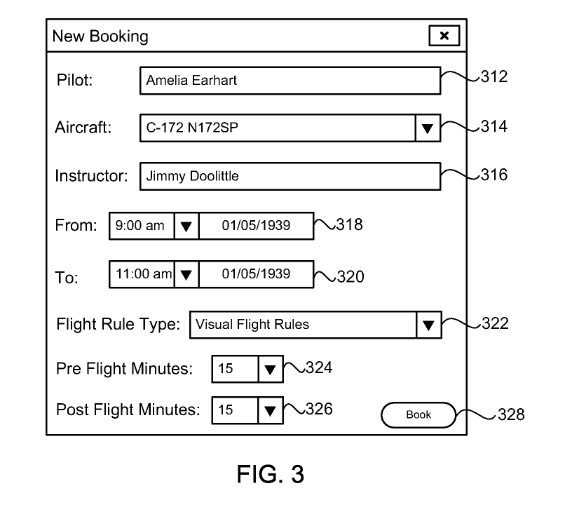

FIG. 3 is a diagram illustrating an example graphical user interface that may be used to schedule a flight event. A user wishing to schedule a flight event, such as a flight lesson, may be presented with a graphical user interface similar to that of FIG. 3 to book the flight event. A user may provide information that may include the pilot 312 who will be piloting an aircraft during the lesson. A flight resource, such as an aircraft 314 that may be reserved for the flight event. An instructor 316 who may be providing instruction during the flight event. A start time 318 and an end time 320 for the flight event. Flight rules 322 that may be used for a flight lesson as well as pre-flight minutes 324 and post-flight minutes 326 that may be used as part of a flight lesson. After entering information for the flight event, the user may book 328 the flight event and the flight event may be added to a flight event schedule.

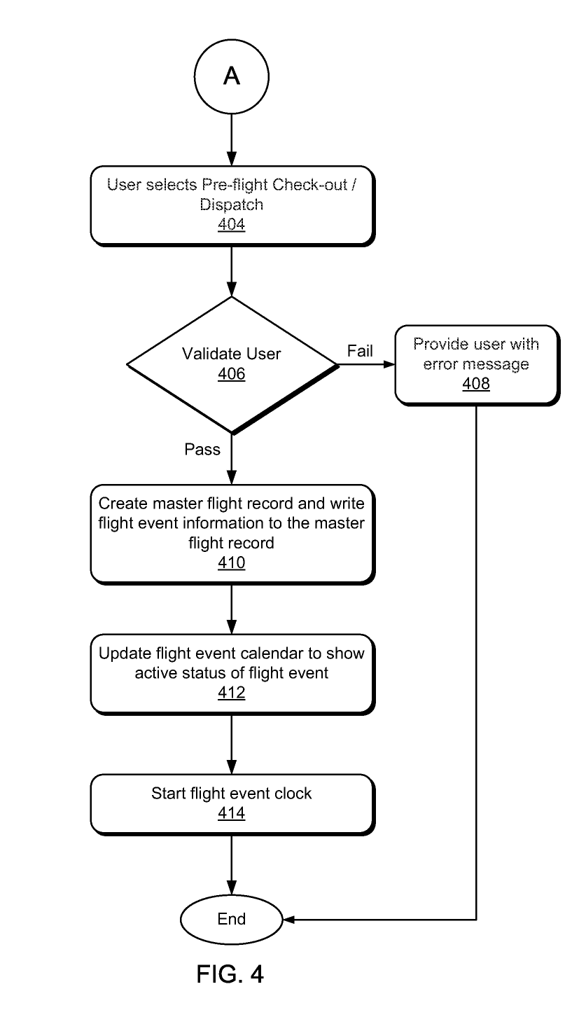

FIG. 4 is a flow diagram illustrating an example of a method for a preflight check-out (dispatch) for a flight event that has been scheduled using a flight management system. Beginning in block 404, when checking out a scheduled flight event, a user may have an option to conduct a pre-flight check, a pre-flight briefing or some other type of pre-flight event. As an example, a flight lesson may be a type of flight event where a pre-flight briefing may be performed prior to the flight lesson. The pre-flight briefing may provide an instructor an opportunity to review details of the flight lesson with a student pilot before entering an aircraft. When a pre-flight event takes place, a user of the flight management system may check-out the flight event at that time.

As in block 406, upon accessing the flight management system to check-out the flight event, a user and any flight resources and/or other members of a party participating in the flight event may be validated to ensure that all flight resources and persons are authorized and cleared to check-out the flight event. User roles and user profiles may be identified for all participants and may be used to validate the participants. As an example, a flight lesson may involve a student pilot and an instructor. When the instructor accesses the flight management system to check-out the flight lesson, a user role may be identified for the instructor and used to verify that the instructor has an instructor role that provides the instructor with system rights to check-out a flight lesson. A user profile may then be identified for both the instructor and the student pilot and the user profiles may be examined to determine whether the instructor and the student pilot have proper profiles containing information that allows the instructor to conduct a flight lesson and the student pilot to participate in a flight lesson. In a case where a user or another participant of a flight event cannot be validated, as in block 408, the user may be provided with an error message that provides the user with a reason why the pre-flight check-out could not be performed.

In a case where a user and other participants of a flight event can be validated, as in block 410, a master flight record may be created and information pertaining to the flight event may be written to the master flight record. For example, a date, a start time for the pre-flight event, a pilot, an instructor and/or a flight resource (e.g., an aircraft) may be written to a master flight record. As in block 412, a flight event schedule can be updated to show the active status of the flight event. For example, a graphical user interface may display a scheduling calendar with blocks of time that show that a flight event has been scheduled for the block of time. The block of time in the scheduling calendar can be updated to show that the scheduled flight event is active (i.e., has started). As in block 414, a timer or a clock that records a time for the flight event may be started and may continue until the associated pre-flight event ends.

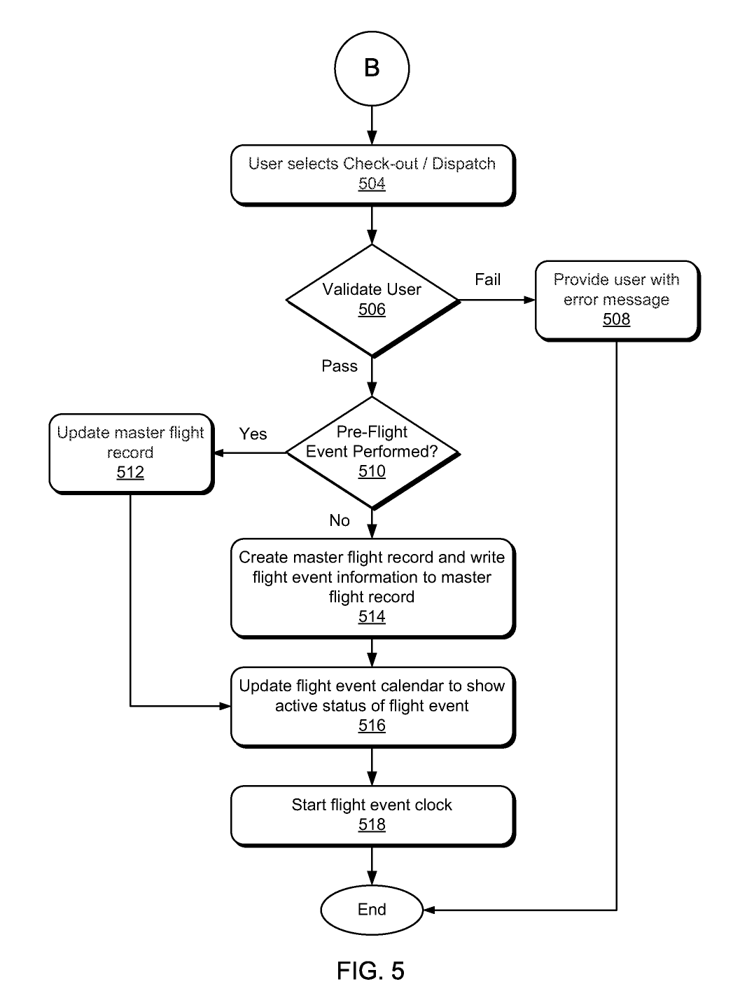

Moving now to FIG. 5, a flow diagram illustrating an example method for checking-out a flight event is shown. As in block 504, a user may check-out (dispatch) a scheduled flight event by accessing a flight management system. Using a graphical user interface, the user can select a flight event that the user wishes to check-out. Upon selecting a flight event to check-out, the user and any persons and/or flight resources that may be associated with the flight event may be validated 506 as discussed in FIG. 4. In a case where a person or a flight resource does not pass a validation check, as in block 508, a user may be provided with an error message and an explanation of the validation failure.

In a case where all persons and flight resources associated with the scheduled flight event passes the validation check, as in block 510, a determination may be made as to whether a pre-flight event may have been performed. Where a pre-flight event has been performed, a master flight record may have been created for the flight event and therefore may already exist. As in block 512, the existing master flight record may be updated with additional check-out information. For instance, when the master flight record was created during the pre-flight event check-out, information may have been written to the master flight record, such as a start time for the pre-flight event. During check-out for a flight event when a pre-flight event may have been performed prior to checking-out the flight event, additional information may be written to the existing master flight record, such as an ending time for the pre-flight event and a starting time for the flight event.

In a case where a pre-flight event was not performed, as in block 514, a master flight record may be created and flight event information can be written to the master flight record. As in block 516, a flight event calendar may be updated to show the active status of the flight event to anyone that may view the flight event calendar as described in FIG. 4. As in block 518, a flight event timer or clock may be started and may track an amount of time expended during the performance of the flight event, and the flight event clock may be stopped at the conclusion of the flight event when the flight event is checked-in.

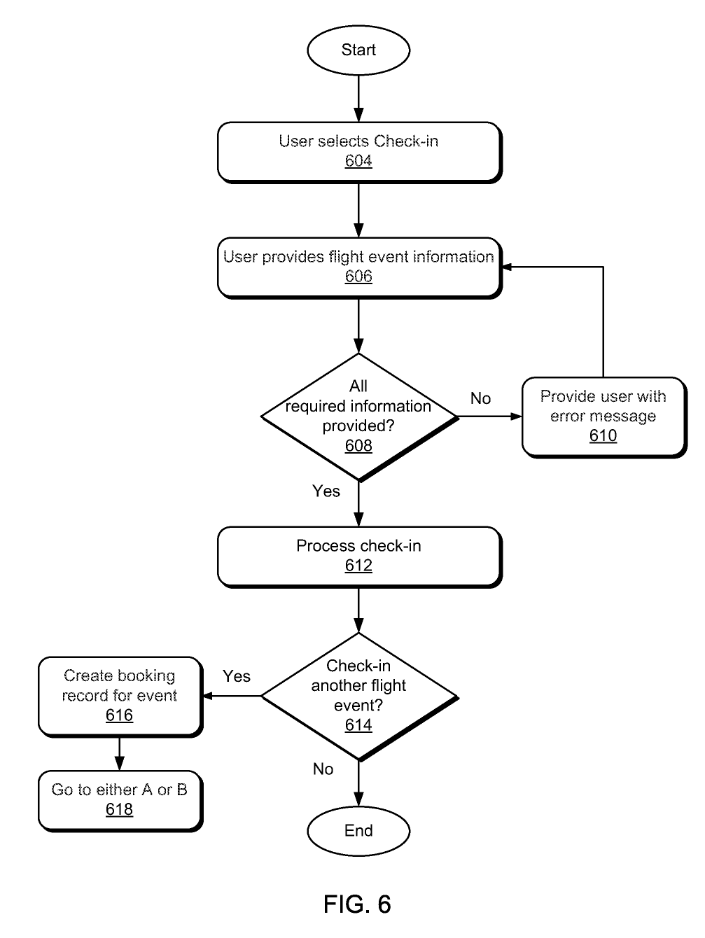

FIG. 6 is a flow diagram illustrating an example method for checking-in a flight event. Starting in block 604, at the conclusion of a flight event, a user may access a flight management system and select a flight event from a graphical user interface that the user would like to check-in. Upon selecting a flight event to check-in, a graphical user interface containing a form and a number of fields may be displayed that allows the user to enter information. As in block 606, the user may provide information about the flight event by entering the information into the fields of the form. For instance, where a flight event may be a flight lesson, the user may provide details about the flight lesson, such as a number of take offs and landings performed, maneuvers that may have been performed, etc. As in block 608, a process may determine whether the user has provided information that may be considered necessary. For example, at check-in, a user may need to provide a billing time, an aircraft service time and a total flying time. In a case where a user may not have included needed information, as in block 610, an error message may be provided to the user informing the user of any needed information that may be missing.

In a case where all needed information may have been provided by the user, as in block 612, the flight event may be checked-in and any associated information may be processed. As an example, processing a check-in may include, but is not limited to: updating the master flight record with the check-in information, creating a billing record, updating flight resources (e.g., updating aircraft data) and creating a lesson record for a flight lesson.

After checking-in the flight event, as in block 614, a user can check-in additional flight events that may be associated with the original flight event that the user just checked-in. For example, where a flight event may be a flight lesson, the flight lesson may have resulted in multiple flight lessons rather than a single flight lesson. Instead of creating, scheduling and checking-out a flight lesson for each flight lesson that resulted from the original flight lesson, a flight management system can provide a user with an option to check-in the additional flight lessons at the time the original flight lesson is checked-in. As another example of a multiple flight event check-in, a charter flight may result in multiple flight events. In such a case, a flight might be chartered by an individual to fly from an originating city to a first city. After arriving at the first city, a second individual may wish to charter the aircraft back to the originating city. In this type of scenario, the originating chartered flight (the originating city to the first city) can be checked-in, and then the additional chartered flight (first city back to the originating city) can be checked-in at the time the original chartered flight is checked-in.

In a case where the user would like to check-in another flight event, as in block 616, a booking record may be created for the flight event whereupon the flight event may be created and information from the originating flight event may be used. For example, where the originating flight event is a flight lesson, information about the flight lesson may be used to create the booking record for the additional flight lesson, such as date, student pilot, instructor, etc. Once the booking record has been created for the additional flight lesson, as in block 618, a process may then be executed as described in FIG. 4 and/or FIG. 5, wherein the additional flight event may be checked-out and a master flight record may be created for the additional flight event, and then the additional flight event may be checked-in by the user as shown in FIG. 6.

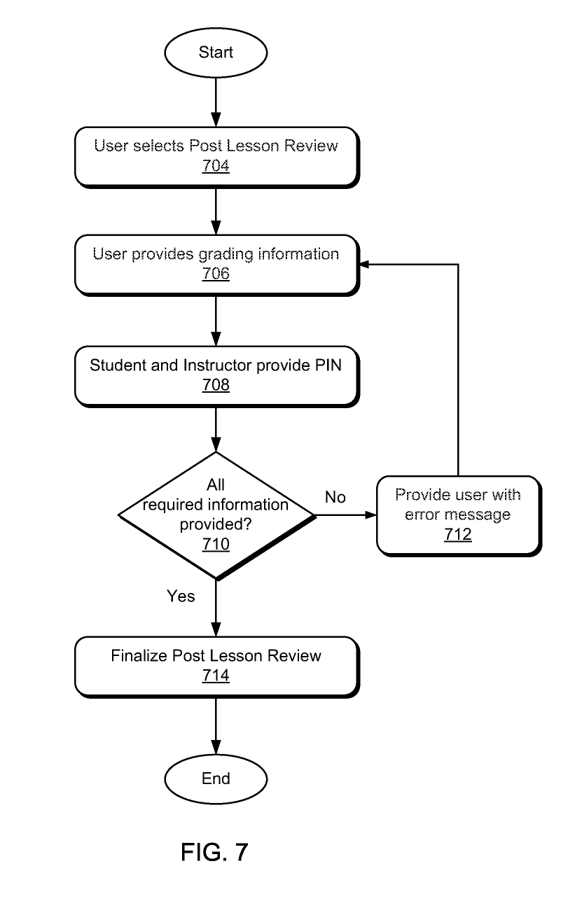

FIG. 7 is a flow diagram illustrating an example method for performing a post lesson review for a flight lesson. Beginning in block 704, a user may access a flight management system and select a flight lesson for which the user would like to perform a post lesson review. As in block 706, a graphical user interface may be provided that allows the user to provide grading information for the flight lesson. For example, a form may be provided that enables a user to enter a grade for a flight lesson, notes for the flight lesson as well as other information that may be related to the flight lesson.

Once a grade and any other information that may be associated with a flight lesson has been entered, as in block 708, an instructor and a student pilot may enter a PIN (personal identification number) that can be used as a signature. In some cases, FAA (Federal Aviation Administration) rules and/or regulations may stipulate that an instructor and a student pilot provide a signature for a flight lesson. By providing a PIN, an instructor and a student pilot can comply with these federal rules.

Having provided a grade, PINs and other information, as in block 710, a process may be used to determine whether all needed information may be present and correct. For example, fields within a form may be examined to ensure that an instructor has provided a PIN, that a student pilot has provided a PIN, that a grade for the flight lesson has been provided, and that any other needed information may be present. In a case where all needed information may not be present, as in block 712, an error message may be provided to a user that explains any deficiencies that may exist in the information of the post-flight review. In a case where all needed information may be present, as in block 714, the post lesson review may be finalized. In one example, the post lesson review may be finalized by updating a master flight record associated with the flight lesson with the post lesson review information and updating a grading record for the flight lesson.

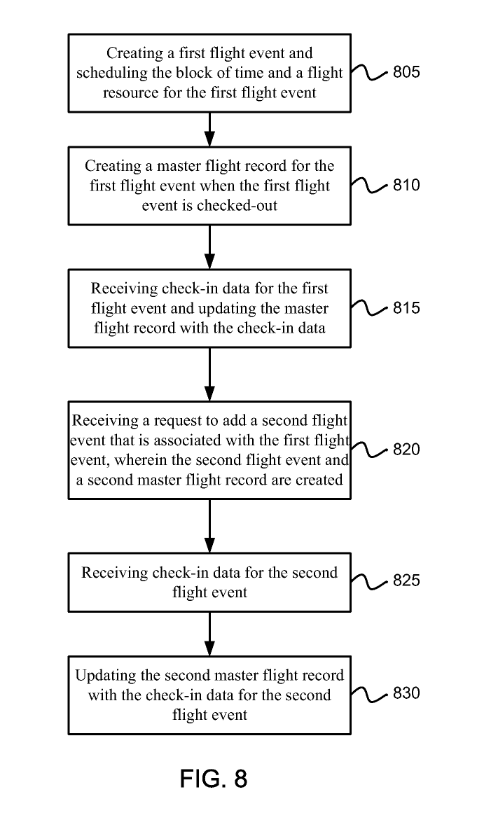

FIG. 8 is a flow diagram illustrating an example method for scheduling, checking-out and checking-in a flight event. As in block 805, a first flight event can be created and a block of time can be scheduled for the first flight event along with a flight resource. After receiving a request to schedule a flight event, a flight event schedule may be queried to determine whether the block of time requested for the flight event may be available. In the event that the block of time is available, the block of time may be displayed in the flight event schedule as unavailable to others who may view the flight event schedule. In one example, the flight event schedule can be shared with a number of users and/or linked with other schedules or calendars so that others viewing the schedules or calendars may see that a block of time may be unavailable to schedule a flight event.

Upon scheduling the first flight event, a request may be received to reserve the flight resource for the block of time. A flight resource may be, but is not limited to: an instructor, a room (e.g., classroom), classroom materials, a workstation and/or a flight simulator. Once a flight event is scheduled, a notification may be provided to persons who may be participating in the flight event. For instance, where a flight event may be a charter flight, a notification may be sent to a pilot and any passengers that may be flying on the charter flight that the charter flight has been scheduled.

As in block 810, a master flight record may be created for the first flight event when the first flight event is checked-out. The master flight record can contain information pertaining to the first flight event and may be used in various flight management system processes. For instance, a master flight record can be used to ensure that compliance with FAA rules and regulations are being adhered to, as well as proprietary rules of a flight entity.

As in block 815, check-in data may be received for the first flight event, including needed data such as billing time, aircraft service time, total flight time, aircraft maintenance information, etc. The master flight record can then be updated with the check-in data. After receiving check-in data, as in block 820, a request to add a second flight event that is associated with the first flight event may be received. As was discussed earlier, a second flight event and a second master flight record may be created when the second flight event request is received. Thereupon, as in block 825, check-in data for the second flight event may be received and, as in block 830, the second master flight record can be updated with the check-in data for the second flight event as was also discussed earlier.

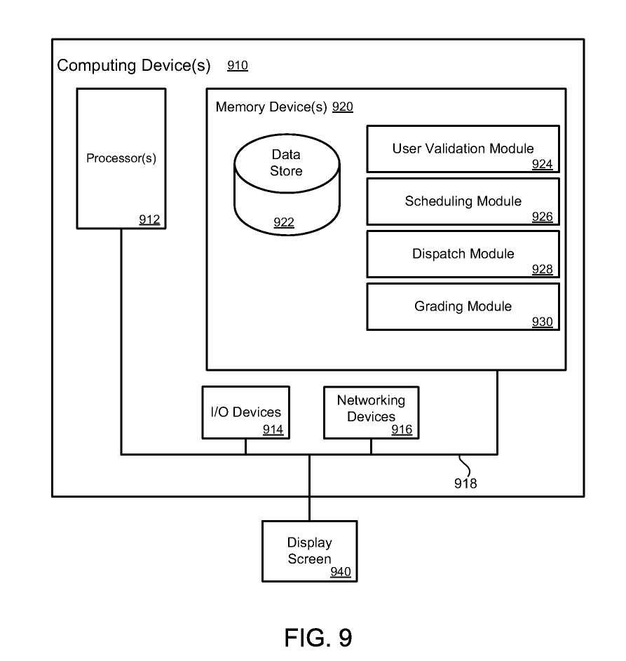

FIG. 9 illustrates a computing device 910 on which modules of this technology may execute. A computing device 910 is illustrated on which a high level example of the technology may be executed. The computing device 910 may include one or more processors 912 that are in communication with memory devices 920. The computing device 910 may include a local communication interface 918 for the components in the computing device. For example, the local communication interface may be a local data bus and/or any related address or control busses as may be desired.

The memory device 920 may contain modules that are executable by the processor(s) 912 and data for the modules. Located in the memory device 920 are services and modules executable by the processor. For example, a user validation module 924, scheduling module 926, dispatch module 928, grading module 930 and other modules may be located in the memory device 920. The modules may execute the functions described earlier. A data store 922 may also be located in the memory device 920 for storing data related to the modules and other applications along with an operating system that is executable by the processor(s) 912.

Other applications may also be stored in the memory device 920 and may be executable by the processor(s) 912. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen 940 that is available to display output from the computing devices. Other known I/O device may be used with the computing device as desired. Networking devices 916 and similar communication devices may be included in the computing device. The networking devices 916 may be wired or wireless networking devices that connect to the internet, a LAN, WAN, WLAN, WWAN, or other computing network, as previously discussed.

The components or modules that are shown as being stored in the memory device 920 may be executed by the processor(s) 912. The term “executable” may mean a program file that is in a form that may be executed by a processor 912. For example, a program in a higher level language may be compiled into machine code in a format that may be loaded into a random access portion of the memory device 920 and executed by the processor 912, or source code may be loaded by another executable program and interpreted to generate instructions in a random access portion of the memory to be executed by a processor. The executable program may be stored in any portion or component of the memory device 920. For example, the memory device 920 may be random access memory (RAM), read only memory (ROM), flash memory, a solid state drive, memory card, a hard drive, optical disk, floppy disk, magnetic tape, or any other memory components.

The processor 912 may represent multiple processors and the memory 920 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, non-transitory media such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A method for scheduling, dispatching and checking-in a flight event, comprising:
under control of one or more computer systems configured with executable instructions,
receiving a request to schedule a block of time for the flight from a user;
creating a first flight event and scheduling the block of time and a flight resource for the first flight event;
creating a master flight record for the first flight event when the first flight event is checked-out;
receiving check-in data for the first flight event and updating the master flight record with the check-in data;
receiving a request to add a second flight event that is associated with the first flight event, wherein the second flight event and a second master flight record are created;
receiving check-in data for the second flight event; and
updating the second master flight record with the check-in data for the second flight event.

2. A method as in claim 1, further comprising authenticating the user to determine whether the user has system rights to create a flight event based on a user role and whether the user has a user profile that enables the user to create the flight event.

3. A method as in claim 1, further comprising validating check-in data against flight criteria.

4. A method as in claim 1, further comprising providing a notification to a pilot and an instructor that a flight event has been scheduled.

5. A method as in claim 1, wherein receiving a request to schedule a block of time for a flight further comprises receiving a request to schedule a flight resource that will be used during the block of time.

6. A method as in claim 5, wherein the flight resource is an aircraft, a classroom, a pilot, an instructor, a room, classroom materials, a workstation, or a simulator.

7. A method as in claim 1, wherein the master flight record for a flight event includes information about the flight event selected from the group consisting of a date, a start time, an end time, a pilot, an instructor, a lesson, a flight plan, a hobbs meter start time, a hobbs meter end time, flight notes, aircraft notes, maintenance events or a flight resource.

8. A method as in claim 1, wherein creating a master flight record for the flight event when the flight is checked-out further comprises creating the master flight record when a pre-flight check-out is performed.

9. A method as in claim 8, further comprising updating the master flight record during check-out when the master flight record is created during the pre-flight check-out.

10. A method as in claim 8, wherein a pre-flight check-out is a pre-flight briefing.

11. A method as in claim 1, wherein the user role defines user privileges for the user within a flight management system and the user profile provides attributes associated with the user within the flight management system.

12. A non-transitory machine readable storage medium, including program code, when executed to cause a machine to perform the method of claim 1.

13. A computing node operable to schedule and dispatch a flight lesson, having computer circuitry configured to:
receive a request to schedule a block of time for a flight lesson from a user;
schedule the block of time for the flight lesson and creating a flight lesson event;
create a master flight record for the flight lesson event upon checking-out the flight lesson event;
receive flight lesson data for the flight lesson event when the flight lesson event is checked-in and validate the flight lesson data against flight lesson criteria; and
update the master flight record with the flight lesson data.

14. The computer circuitry of claim 13, wherein receiving flight lesson data for the flight lesson event when the flight lesson event is checked-in further comprises receiving flight lesson data for additional flight lessons, wherein a flight lesson event and a master flight record is created for each of the additional flight lessons.

15. The computer circuitry of claim 13, further comprising computer circuitry configured to receive a post-flight review from a pilot or an instructor that includes information used to grade the flight lesson and update the master flight record with a grade for the flight lesson.

16. The computer circuitry of claim 15, further comprising computer circuitry configured to notify the pilot or the instructor of any deficiencies that exist in the information of the post-flight review.

17. The computer circuitry of claim 15, further comprising computer circuitry configured to receive a personal identification number (PIN) associated with the pilot or the instructor, wherein the PIN is used as a signature for the pilot or the instructor to comply with government flight standards or proprietary flight entity standards.

18. The computer circuitry of claim 13, further comprising computer circuitry configured to query a flight schedule to inquire whether the block of time requested for the flight lesson is available and display the block of time as unavailable in the flight schedule to other users upon scheduling the block of time.

19. The computer circuitry of claim 18, further comprising computer circuitry configured to share with a plurality of linked flight schedules the block of time that is selected for the flight lesson, wherein the block of time is displayed on the plurality of linked flight schedules.

20. A system for scheduling and dispatching a flight event, comprising:
a computing device having a processor;
a flight schedule stored in a data store accessible to the computing device;
a master flight record stored in the data store accessible to the computing device;
a memory device including instructions, that when executed by the processor, cause the processor to execute:
a user validation module to validate a user requesting to create the flight event, wherein a user role and a user profile are used to determine whether the user is credentialed to create the flight event and whether the user meets criteria to create the flight event;
a scheduling module to receive a request to schedule a block of time for the flight event and to schedule the block of time and a flight resource for the flight event; and
a dispatch module to check-out a flight event and to check-in the flight event and at least one additional flight event associated with the flight event.

21. A system as in claim 18, further comprising a grading module to receive a post-flight review from a pilot or an instructor that includes information used to grade the flight event and update the master flight record with a grade for the flight event.
